(19) United States
(12) Patent Application Publication
(10) Pub. No.: US 2012/0268424 A1
(43) Pub. Date: Oct. 25, 2012

(54) METHOD AND APPARATUS FOR RECOGNIZING GESTURE OF IMAGE DISPLAY DEVICE

(76) Inventors: Taehyeong KIM, Suwon (KR); Sangki Kim, Busan (KR); Soungmin Im, Seoul (KR)

(21) Appl. No.: 13/090,617

(22) Filed: Apr. 20, 2011

(51) Int. Cl. G06F 3/042

(52) U.S. Cl. 345/175

(57) ABSTRACT

An image display device capable of providing a realistic interface by increasing a response speed of a gesture recognition by reducing the amount of calculation, and a method for controlling an operation thereof are disclosed. The method for controlling an operation of an image display device includes: capturing a first image by using a camera and extracting depth data from the captured first image; detecting a first object by using a peak value from the depth data extracted from the first image; capturing a second image by using the camera and extracting depth data from the captured second image; detecting a second object by using a peak value from the depth data extracted from the second image; and designating the second object as an interested object based on the distance between the first and second objects.

### BACKGROUND OF THE INVENTION

1. Field of the Invention

The present invention relates to an image display device and a method for controlling an operation thereof, and more particularly, to an image display device capable of recognizing a gesture by using a camera and a method for controlling an operation of the image display device.

2. Description of the Related Art

An image display device is a device having a function of displaying an image which may be viewed by a user. That is, the user can view a broadcast through such an image display device. The image display device displays a broadcast selected by the user from among broadcast signals transmitted from a broadcast station. Currently, broadcasts are changing from analog broadcasts to digital broadcasts worldwide.

A digital broadcast refers to a broadcast transmitting a digital image and a voice signal. Compared with an analog broadcast, the digital broadcast is resistant to external noise to have a small data loss, is advantageous for an error correction, has high resolution, and provides a sharp screen image. Also, the digital broadcast Recently, a sensing technique that measures information relevant to a user's physical condition has been advancing, so an apparatus for conveniently monitoring a user's physical condition by using such a sensing technique is requested to be considered.

### SUMMARY OF THE INVENTION

Accordingly, an object of the present invention is to address the above-noted and other problems.

Another object of the present invention is to provide an image display device capable of providing a realistic interface by increasing a response speed of a gesture recognition by reducing the amount of calculation, and a method for controlling an operation thereof.

Another object of the present invention is to provide an image display device capable of accurately recognizing a user's intention of controlling the device, and a method for controlling an operation thereof.

According to an aspect of the invention, there is provided a method for controlling an operation of an image display device, including: capturing a first image by using a camera and extracting depth data from the captured first image; detecting a first object by using a peak value from the depth data extracted from the first image; capturing a second image by using the camera and extracting depth data from the captured second image; detecting a second object by using a peak value from the depth data extracted from the second image; and designating the second object as an interested object based on the distance between the first and second objects.

The method may further include: capturing a third image by using the camera and extracting depth data from the captured third image; detecting a third object by using a peak value from the depth data extracted from the third image; and maintaining or releasing the designated interested object based on the distance between the interested object and the third object.

The method may further include: storing the distance by which a body part of a user is movable by unit time, wherein in maintaining or releasing the designated interested object, the designated interested object may be maintained or released further based on the distance by which the body part of the user is movable by unit time.

The method may further include: capturing a third image by using the camera and extracting depth data from the captured third image; detecting third and fourth objects by using a peak value from the depth data extracted from the third image; and maintaining or releasing the designated interested object based on the distance between the interested object and the third object and the distance between the interested object and the fourth object.

The method may further include: displaying a first indicator reflecting the location of the interested object.

The method may further include: displaying a second indicator reflecting the locations of the first and second objects such that the second indicator is differentiated from the first indicator.

The extracting of the depth data from the captured second image may include: extracting user's shape information or user's posture information from the captured second image, and in determining the second object as an interested object, the second object may be designated as an interested object based on the user's shape information or posture information.

The method may further include: displaying guide information related to the location of the second object on a screen.

The method may further include: detecting a user's gesture through the interested object; and executing a command corresponding to the gesture in response to the gesture.

The method may further include: determining the type of reproduced contents, and in designating the second object as an interested object, the second object may be designated as an interested object further based on the type of the contents.

The type of the reproduced contents may be classified according to whether or not the reproduced contents are interactive contents.

The type of the reproduced contents may be classified according to whether or not the reproduced contents is broadcast contents.

According to another aspect of the invention, there is provided an image display device including: a camera configured to capture a first image and a second image following the first image; and a controller configured to extract depth data from each of the captured first and second images, detect first and second objects each having a peak value from each of the extracted depth data, and designate the second object as an interested object based on the distance between the first and second objects.

Further scope of applicability of the present invention will become apparent from the detailed description given hereinafter. However, it should be understood that the detailed description and specific examples, while indicating preferred embodiments of the invention, are given by illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings, which are given by illustration only, and thus are not limitative of the present invention, and wherein:

FIG. 1 is a schematic view showing an example of an overall broadcast system including an image display device according to an exemplary embodiment of the present invention;

FIG. 2 is a schematic block diagram of the image display device of FIG. 1;

FIGS. 3 and 4 are schematic block diagrams discriminately showing a set-top box (STB) and a display device of any one of image display devices according to exemplary embodiments of the present invention;

FIG. 5 is a detailed view showing a camera unit of an image display device according to an exemplary embodiment of the present invention;

FIGS. 6A and 6B are flow charts illustrating the process of controlling an operation of the image display device according to an exemplary embodiment of the present invention;

FIGS. 7A and 7B are views for explaining the process of designating an interested object according to an exemplary embodiment of the present invention;

FIGS. 8A and 8B are views for explaining the process of designating an interested object according to an exemplary embodiment of the present invention;

FIGS. 9A and 9B are views for explaining the process of tracking an interested object according to an exemplary embodiment of the present invention;

FIGS. 10A to 10C are views for explaining the process of tracking an interested object according to an exemplary embodiment of the present invention;

FIGS. 11A to 11C are views for explaining the process of tracking an interested object according to an exemplary embodiment of the present invention;

FIGS. 12A to 12C are views for explaining the process of tracking an interested object according to an exemplary embodiment of the present invention;

FIGS. 13A to 13E are views for explaining the process of maintaining or releasing a designated interested object according to an exemplary embodiment of the present invention;

FIG. 14 is a view for explaining the process of detecting an object according to an exemplary embodiment of the present invention;

FIG. 15 is a view for explaining the process of detecting an object according to an exemplary embodiment of the present invention; and

FIG. 16 is a view for explaining the process of detecting an object according to an exemplary embodiment of the present invention.

### DETAILED DESCRIPTION OF THE INVENTION

Exemplary embodiments of the present invention will now be described with reference to the accompanying drawings.

In the following description, usage of suffixes such as ‘module’, ‘part’ or ‘unit’ used for referring to elements is given merely to facilitate explanation of the present invention, without having any significant meaning by itself.

Meanwhile, the image display device described in the present disclosure is, for example, an intelligent image display device crafted by adding a computer supporting function to a broadcast receiving function, and as such, the image display device can have an interface convenient for using a handwriting recognition type input device, a touch screen, a space remote controller, or the like. Also, supporting wired or wireless Internet function, the image display device can be connected to the Internet or a computer to send an e-mail, perform Web browsing, banking transaction, playing games, or the like. For these various functions, a standardized general-purpose operating system (OS) may be used for the image display device.

Accordingly, the image display device described in the present disclosure allows for various applications to be freely added on a general-purpose OS kernel or deleted therefrom, thus performing user-friendly various functions. The image display device may be, for example, a network TV, an HBBTV, a smart TV, or the like, or may be applicable to a smartphone.

In addition, the exemplary embodiments of the present invention will now be described in detail with reference to the accompanying drawings, but the present invention is not limited to the exemplary embodiments.

Terms used in the present disclosure are currently widely used general terms selected in consideration of the functions in the present invention; however, they may be changed according to the intention of a person skilled in the art, custom, the advent of a novel technology, or the like. Also, the terms may include those arbitrarily selected by the applicant in particular cases, and in this case, the meaning of the terms will be described in a description part of the corresponding invention. Thus, it will be appreciated that the terms used in the present disclosure must be construed based on substantial meanings of the terms, rather than the simple title of the terms, and general content of the present disclosure.

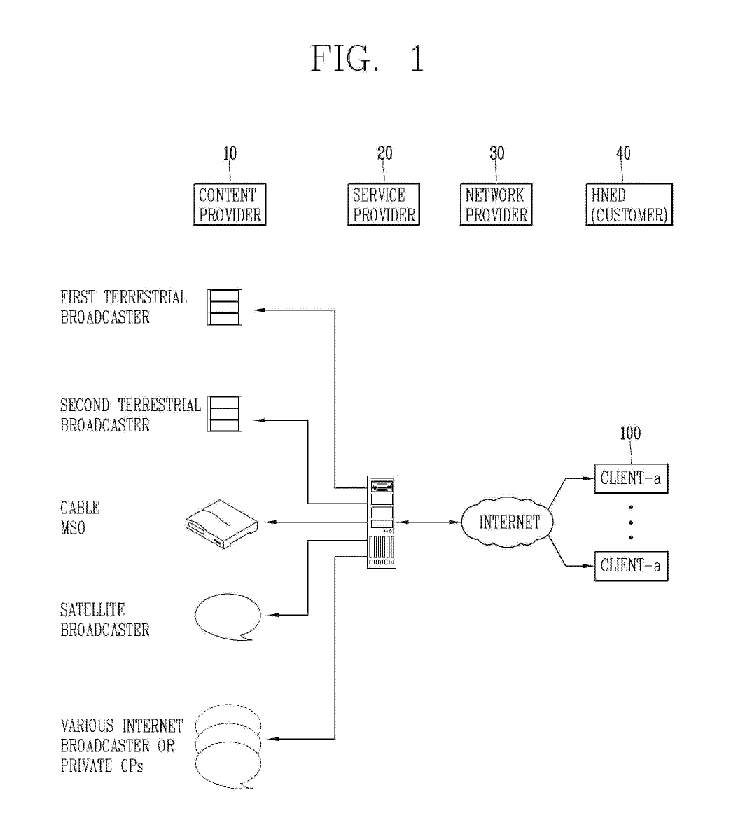

FIG. 1 is a schematic view showing an example of an overall broadcast system including an image display device according to an exemplary embodiment of the present invention.

As shown in FIG. 1, the overall broadcast system including the image display device according to an exemplary embodiment of the present invention may include a content provider (CP) 10, a service provider (SP) 20, a network provider (NP) 30, and a home network end device (HNED) 40. The HNED 40 corresponds to, for example, a client 100, an image display device according to an exemplary embodiment of the present invention. The client 100 corresponds to the image display device according to an exemplary embodiment of the present invention, and the image display device may be, for example, a network TV, a smart TV, an IPTV, or the like.

The content provider 10 creates various contents and provides the same. As shown in FIG. 1, the contents provider 10 may be, for example, a terrestrial broadcaster, a cable system operator (SO), a multiple system operator (MSO), a satellite broadcaster, an Internet broadcaster, and the like.

The contents provider 10 may provide various applications, or the like, other than broadcast contents. This will be described in more detail later.

The service provider 20 may package the contents provided by the contents provider 10 and provide the same. For example, the service provider 20 in FIG. 1 may package a first terrestrial broadcast, a second terrestrial broadcast, a cable MSO, a satellite broadcast, various Internet broadcasts, applications, or the like, and provide the same to the user.

Meanwhile, the service provider 20 may provide a service to the client 100 according to a unicast scheme or a multicast scheme. The unicast scheme is a scheme of transmitting data between a sender and a recipient in a one-to-one manner. For example, in case of the unicast scheme, when a receiver requests data from a server, the server may transmit data to the receiver according to the corresponding request. The multicast scheme is a scheme of transmitting data to a plurality of receivers which have been previously registered. For example, a server may transmit data to the plurality of receivers which have been previously registered at a time. For such a multicast registration, an IGMP (Internet Group Management Protocol), or the like, may be used.

The network provider 30 may provide a network for providing a service to the client 100. The client 100 may establish a home network end device (HNED) to be provided a service.

In order to protect contents transmitted in the image display device system, a conditional access, content protection, or the like, may be used. For example, a cable card, a DCAS (Downloadable Conditional Access System), or the like, may be used for the conditional access or content protection.

Meanwhile, the client 100 may provide contents through a network. In this case, unlike the above description, conversely, the client 100 may be a contents provider and the contents provider 10 may receive contents from the client 100. In this configuration, a bi-directional contents service or data service can be provided.

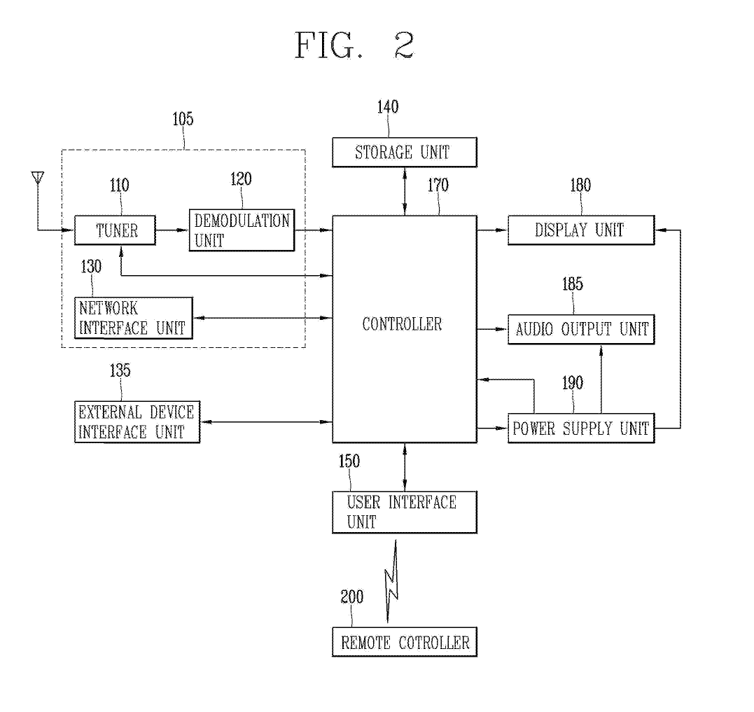

FIG. 2 is a schematic block diagram of the image display device of FIG. 1.

With reference to FIG. 2, the image display device 100 according to an exemplary embodiment of the present invention may include a broadcast receiving unit 105, an external device interface unit 135, a storage unit 140, a user input interface unit 150, a controller 170, a display unit 180, an audio output unit 185, a power supply unit 190, and a camera unit (not shown). The broadcast receiving unit 105 may include a tuner 110, a demodulation unit 120, and a network interface unit 130. Of course, the broadcast receiving unit 105 may be configured to include only the tuner 110 and the demodulation unit 120 without the network interface unit 130, or may include only the network interface unit 130 without the tuner 110 and the demodulation unit 120, as necessary.

The tuner 110 selects an RF broadcast signal corresponding to a channel selected by the user from among RF (Radio Frequency) broadcast signals received through an antenna or all the stored channels. Also, the tuner 110 converts the selected RF broadcast signal into an IF (Intermediate Frequency) signal or a baseband image or voice signal.

For example, when the selected RF broadcast signal is a digital broadcast signal, the tuner 110 converts the digital broadcast signal into a digital IF (DIF) signal, and when the selected RF broadcast signal is an analog broadcast signal, the tuner 110 converts the analog broadcast signal into an analog baseband image or a voice signal (CVBS/SIF). Namely, the tuner 110 may process both the digital broadcast signal or the analog broadcast signal. The analog baseband image or the voice signal (CVBS/SIF) may be directly input to the controller 170.

Also, the tuner 110 may receive an RF broadcast signal of a single carrier according to an advance television system committee (ATSC) scheme or an RF broadcast signal of multiple carriers according to a digital video broadcasting (DVB) scheme.

Meanwhile, the tuner 110 is able to receive the sequentially select RF broadcast signals of all the broadcast channels stored by a channel memory function among RF broadcast signals received through the antenna and convert them into IF signals, or baseband image or voice signals.

The demodulation unit 120 receives the digital IF signal (DIF) converged by the tuner 110 and demodulates it.

For example, when the digital IF signal output from the tuner 110 is based on an ATSC scheme, the demodulation unit 120 performs, for example, 8-VSB (8-Vestigal Side Band) demodulation. Also, the demodulation unit 120 may perform channel decoding. To this end, the demodulation unit 120 may include a trellis decoder, a de-interleaver, a Reed Solomon decoder, and the like, to perform trellis decoding, de-interleaving, and Reed Solomon decoding.

For example, when the digital IF signal output from the tuner 110 is based on a DVB scheme, the demodulation unit 120 may perform, for example, a COFDMA (Coded Orthogonal Frequency Division Demodulation) decoding. To this end, the demodulation unit 120 may include a convolution decoder, a de-interleaver, a Reed-Solomon decoder, and the like, to perform decoding, de-interleaving, and Reed Solomon decoding.

The demodulation unit 120 may perform demodulation and channel decoding unit and then output a stream signal (TS). In this case, the stream signal may be a signal in which an image signal, a voice signal, or a data signal is multiplexed. For example, the stream signal may be an MPEG-2 TS (Transport Stream) in which an image signal of an MPEG-2 standard, a voice signal of a Dolby AC-3 standard, or the like, is multiplexed. In detail, the MPEG-2 TS may include 4-byte header and 184-byte payload.

Meanwhile, the foregoing demodulation unit 120 may be separately provided according to an ATSC scheme and a DVB scheme. Namely, both ATSC demodulation unit and a DVB demodulation unit are separately provided.

The stream signal output from the demodulation unit 120 may be input to the controller 170. The controller 170 performs demultiplexing, image/voice signal processing, or the like, on the input stream signal, and outputs an image to the display unit 180 and outputs a voice to the audio output unit 185.

The external device interface unit 135 may connect an external device and the image display device 100. To this end, the external device interface unit 135 may include an A/V input/output unit (not shown) or a wireless communication unit (not shown).

The external device interface unit 135 may be connected to an external device such as a DVD (Digital Versatile Disk), a Blu-ray, a game machine, a camera, a camcorder, a computer (notebook computer), or the like, through a fixed line or wirelessly. The external device interface unit 135 delivers an image, voice, or data signal input from the exterior through the external device connected thereto to the controller 170 of the image display device 100. Also, the external device interface unit 135 may output an image, voice, or data signal processed by the controller 170 to the external device connected thereto. To this end, the external device interface unit 135 may include an A/V input/output unit (not shown) or a wireless communication unit (not shown).

The NV input/output unit may include a USB port, a CVBS (Composite Video Banking Sync) port, a component port, an S-video port (analog), a DVI (Digital Visual Interface) port, an HDMI (High Definition Multimedia Interface) port, an RGB port, a D-USB port, and the like, in order to input an image and voice signals from an external device to the image display device 100.

The wireless communication unit may perform short-range wireless communication with an electronic device. The image display device 100 may be connected to a different electronic device through a network according to a communication standard such as Bluetooth™, radio frequency identification (RFID), infrared data association (IrDA), ultra-wideband (UWB), ZigBee™, DLNA (Digital Living Network Alliance), or the like.

Also, the external device interface unit 135 may be connected to various set-top boxes (STBs) through at least one of the foregoing various terminals and perform an input/output operation with the STBs.

Meanwhile, the external device interface unit 135 may receive an application or an application list in an adjacent external device and deliver the same to the controller 170 or the storage unit 140.

The network interface unit 130 provides an interface for connecting the image display device 100 to a wired/wireless network including the Internet. For a connection to the wired network, the network interface unit 130 may include, for example, an Ethernet port, or the like, and for a connection to the wireless network, the network interface unit 130 may use a communication standard such as a WLAN (Wireless LAN) (Wi-Fi), Wibro (Wireless broadband), Wimax (World Interoperability for Microwave Access), HSDPA (High Speed Downlink Packet Access), or the like.

The network interface unit 130 may transmit or receive data to a different user or a different electronic device through a network connected to the network interface unit 130 or through a different network linked to the network connected to the network interface unit 130. In particular, the network interface unit 130 may transmit some contents data stored in the image display device 100 to a user or an electronic device selected from among different users or different electronic devices previously registered to the image display device 100.

Meanwhile, the network interface unit 130 may access a certain Web page through the connected network or the different network linked to the connected network. Namely, the network interface unit 130 may access a certain Web page through the network to transmit or receive data to and from a corresponding server. Besides, the network interface unit 130 may receive contents or data provided by the contents provider or the network operator. Namely, the network interface unit 130 may receive contents such as movie, commercials, games, VOD, broadcast signals, or the like, and relevant information provided from the contents provider or the network provider through the network. Also, the network interface unit 130 may receive firmware update information and an update file provided by a network operator. Also, the network interface unit 130 may transmit data to an Internet, contents provider, or the network operator.

Also, the network interface unit 130 may selectively receive a desired application among applications open to the public through the network.

The storage unit 140 may store programs for processing and controlling respective signals in the controller 170, or store a signal-processed image, voice, or data signals.

Also, the storage unit 140 may serve to temporarily store an image, voice, or data signal input from the external device interface unit 135 or the network interface unit 130. Also, the storage unit 140 may store information regarding a certain broadcast channel through a channel memory function.

Also, the storage unit 140 may store an application or an application list input from the external device interface unit 135 or the network interface unit 130

Also, the storage unit 140 may store mapping data regarding a user gesture and an operation of the image display device or mapping data regarding a user gesture and an operation on an application.

The storage unit 140 may include at least one type of storage mediums among, for example, a flash memory type, a hard disk type, a multimedia card micro type, a card-type memory (e.g., SD or DX memory, etc), a Random Access Memory (RAM), and an Electrically Erasable Programmable Read-Only Memory (EEPROM). The image display device 100 may reproduce a contents file (a video file, a still image file, a music file, a document file, an application file, and the like) stored in the storage unit 140, and provide the same to the user.

FIG. 2 illustrates an embodiment in which the storage unit 140 is provided separately from the controller 170, but the present invention is not limited thereto. The storage unit 140 may be included in the controller 170.

The user input interface unit 150 may transfer a signal input by the user to the controller 170 or transfer a signal from the controller 170 to the user.

For example, the user input interface unit 150 may receive a control signal such as a power ON/OFF, a channel selection, a screen configuration, or the like, from a remote controller 200 according to various communication schemes such as an RF (Radio Frequency) communication scheme, an infrared (IR) communication scheme, and the like, and process the same, or may process a control signal from the controller 170 so as to transmit it to the remote controller 200.

Also, for example, the user input interface unit 150 may transfer a control signal input from a local key (not shown) such as a power key, a channel key, a volume key, a setup key, or the like, to the controller 170.

Also, for example, the user input interface unit 150 may transfer a control signal input from a sensing unit (not shown) for sensing a user's gesture to the controller 170 or transmit a signal from the controller 170 to the sensing unit (not shown). Here, the sensing unit (not shown) may include a touch sensor, a voice sensor, a location sensor, an motion sensor, or the like.

The controller 170 may demultiplex an input stream through the tuner 110, the demodulation unit 120, or the external device interface unit 135, or process demultiplexed signals to generate and output a signal for an image or voice output.

The image signal processed by the controller 170 may input to the display unit 180 so as to be displayed as an image corresponding to the image signal on the display unit 180. Also, the image signal processed by the controller 170 may be input to an external output device through the external device interface unit 135.

The voice signal processed by the controller 170 may be output to the audio output unit 185. Also, the voice signal processed by the controller 170 may be input to an external output device through the external device interface unit 135.

Although not shown in FIG. 2, the controller 170 may include a demultiplexing unit, an image processing unit, or the like.

Besides, the controller 170 may control a general operation in the image display device 100. For example, the controller 170 may control the tuner 110 to select (or tune) an RF broadcast corresponding to a channel selected by the user or a previously stored channel.

Also, the controller 170 may control the image display device 100 by a user command input through the user input interface unit 150 or an internal program. In particular, the controller 170 may access a network to download a user desired application or application list to the image display device 100.

For example, the controller 170 controls the tuner 110 to input a signal of a selected channel according to a certain channel selection command received through the user input interface unit 150. And then, the controller 170 processes an image, voice, or data signal of the selected channel. The controller 170 may provide control to output the user selected channel information, or the like, along with the processed image or voice signal to the display unit 180 or to the audio output unit 185.

In another example, the controller 170 may provide control to output an image signal or a voice signal, which is input from an external device, e.g., a camera or a camcorder, through the external device interface unit 135, to the display unit 180 or the audio output unit 185 according to an external device image reproduction command received through the user input interface unit 150.

Meanwhile, the controller 170 may control the display unit 180 to display an image. For example, the controller 170 may control the display unit 180 to display a broadcast image input through the tuner 110, an external input image input through the external interface unit 135, an image input through the network interface unit, or an image stored in the storage unit 140. In this case, the image displayed on the display unit 180 may be a still image or a video, or a 2D image or a 3D image.

Also, the controller 170 may provide control to reproduce contents. Contents here may be contents stored in the image display device 100, received broadcast contents, or external input contents input from the exterior. The contents may also be at least one of a broadcast image, an external input image, an audio file, a still image, an accessed Web screen image, and a document file.

Meanwhile, according to an exemplary embodiment of the present invention, the controller 170 may control the display unit 180 to display a home screen image according to an input for shifting to a home screen image.

The home screen image may include a plurality of card objects classified by contents sources. The card objects may include at least one of a card object denoting a thumbnail list of broadcast channels, a card object denoting a broadcast reservation list or recording list, and a card object denoting a media list in the image display device or a device connected to the image display device. Also, the card objects may further include at least one of a card object denoting a list of connected external devices and a card object denoting a list related to calls.

Also, the home screen image may further include an application menu having at least one executable application item.

Meanwhile, when there is a card object shift input, the controller 170 may provide control to shift a corresponding card object and display it, or may provide control to shift a card object not displayed on the display unit 180 such that it is displayed on the display unit 180.

Meanwhile, when a certain card object is selected from among a plurality of card objects in the home screen image, the controller 170 may control the display unit 180 to display an image corresponding to the selected card object.

Meanwhile, the controller 170 may provide control to display an object denoting a received broadcast image and information related to the corresponding broadcast image in a card object denoting the broadcast image. Also, the controller 170 may provide control to fix the size of such a broadcast image by setting locking.

Meanwhile, the controller 170 may provide control to display a setup object for setting at least one of an image setup in the image display device, an audio setup, a screen setup, a reservation setup, a setup of a point of a remote controller, a network setup in the home screen image.

Meanwhile, the controller 170 may provide control to display an object with respect to log-in, help, exit items on an area of the home screen image.

Meanwhile, the controller 170 may provide control to display an object denoting the number of all the card objects or the number of card objects displayed on the display unit 180 among all the card objects on an area of the home screen image.

Meanwhile, when a card object name in a certain card object among card objects displayed on the display unit 180 is selected, the controller 170 may control the display unit 180 to display the corresponding card object as an entire screen image.

Meanwhile, when an incoming call is received in the connected external device or the image display device, the controller 170 may control the display unit 180 to display such that a call-related card object, among the plurality of card objects, is focused, or shift the call-related card object into the display unit 180 so as to be displayed on the display unit 180.

Meanwhile, when an application view item is entered, the controller 170 may control the display unit 180 to display an application or an application list of the image display device 100 or display an application or an application list which can be downloaded from an external network.

The controller 170 may provide control to install and drive the application downloaded from the external network along with various user interfaces. Also, the controller 170 may provide control to display an image related to the executed application on the display unit 180 according to a user selection.

Meanwhile, although not shown, a channel browsing processing unit for generating a thumbnail image corresponding to a channel signal or an external input signal may be additionally provided.

The channel browsing processing unit may receive a stream signal (TS) output from the demodulation unit 120 or a stream signal output from the external device interface unit 135 and extract an image from the input stream signal to generate a thumbnail image. The generated thumbnail image may be coded as it is so as to be input to the controller 170. Also, the controller 170 may display a thumbnail list including a plurality of thumbnail images on the display unit 180 by using the input thumbnail image. Meanwhile, the thumbnail images of the thumbnail list may be sequentially or simultaneously updated. Accordingly, the user can simply recognize content of a plurality of broadcast channels.

The display unit 180 may convert an image signal, a data signal, an OSD signal processed by the controller 170, or an image signal, a data signal, or the like, received from the external device interface unit 135 into R, G and B signals to generate driving signals.

The display unit 180 may include a PDP, an LCD, an OLED, a flexible display, a 3D display, or the like.

Meanwhile, the display unit 180 may be configured as a touch screen so as to be used as an input device, as well as an output device.

The audio output unit 185 may receive the voice-processed signal, e.g., a stereoscopic signal, a 3.1 channel signal, or a 5.1 channel signal from the controller 170 and outputs a voice. The voice output unit 185 may be implemented as a speaker having various forms.

Meanwhile, as mentioned above, the image display device 100 may further include a sensing unit (not shown) having at least one of a touch sensor, a voice, sensor, a location sensor, and an motion sensor in order to sense a user's gesture. A signal sensed by the sensing unit (not shown) may be transferred to the controller 170 through the user input interface unit 150.

Meanwhile, a camera unit (not shown) for capturing the user may be further provided. Image information captured by the camera unit (not shown) may be input to the controller 170.

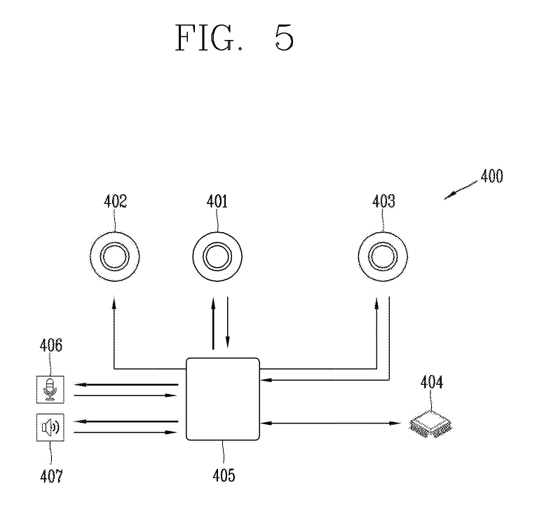

The camera unit (not shown) will be described in detail later with reference to FIG. 5.

The controller 170 may separately use or combine the image captured by the camera unit (not shown) or the signal sensed by the sensing unit (not shown) to detect a user's gesture.

Also, the controller 170 may include an application execution unit (not shown) according to an exemplary embodiment of the present invention.

The application execution unit (not shown) searches an application corresponding to an object recognized by the image recognition unit (not shown) and executes the same.

The power supply unit 190 supplies power to the elements of the image display device 100.

In particular, the power supply unit 190 may supply power to the controller 170 which can be implemented in the form of a system on chip (SOC), the display unit 180 for displaying an image, and the audio output unit 185 for outputting audio signal.

To this end, the power supply unit 190 may include a converter (not shown) for converting AC power into DC power. Meanwhile, when the display unit 180 is implemented as a liquid crystal panel having a plurality of backlight lamps, the display unit 180 may further include an inverter (not shown) available for a PWM operation for luminance varying or dimming driving.

The remote controller 200 transmits a user input to the user input interface unit 150. To this end, the remote controller 200 may use Bluetooth™, RF (Radio Frequency) communication, infrared communication, UWB (Ultra-Wide Band), ZigBee™ scheme, or the like.

The remote controller 200 may receive an image, voice or data signal output from the user input interface unit 150, display the same on the remote controller 20 or may output a voice or vibration

The foregoing image display device 100 may be a digital broadcast receiver which is able to receive at least one of a digital broadcast of an ATSC scheme (8-VSB scheme), a digital broadcast of a DVB-T scheme (COFDM scheme), a digital broadcast of an ISDB-T (BST-OFDM scheme).

Meanwhile, the block diagram of the image display device 100 illustrated in FIG. 2 is a block diagram for an exemplary embodiment of the present invention. Each element of the block diagram may be integrated, added or omitted according to specifications of the image display device to be implemented in actuality. Namely, two or more elements may be integrated into one element, or one element may be divided into two or more elements so as to be configured, as necessary. Also, the function performed by each block is for explaining the exemplary embodiment of the present invention, and the scope of the present invention is not limited by a specific operation and device thereof.

Meanwhile, unlike the case illustrated in FIG. 2, image contents may be received through the network interface unit 130 or the external device interface unit 135 and reproduced, without the tuner 110 and the demodulation unit 120 as shown in FIG. 2.

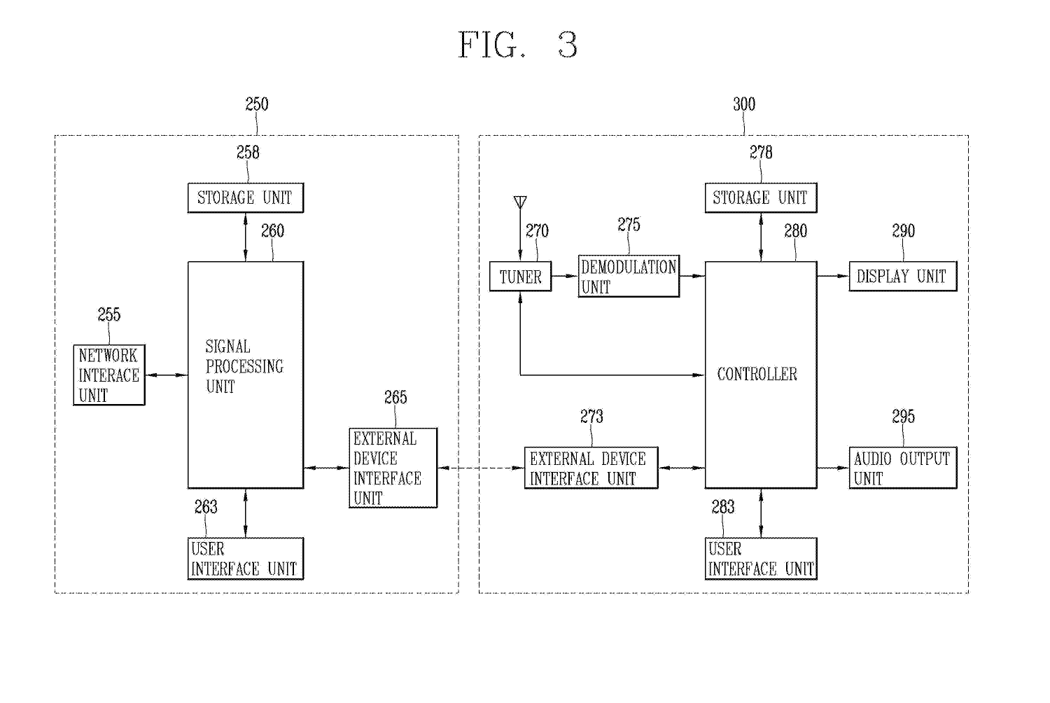

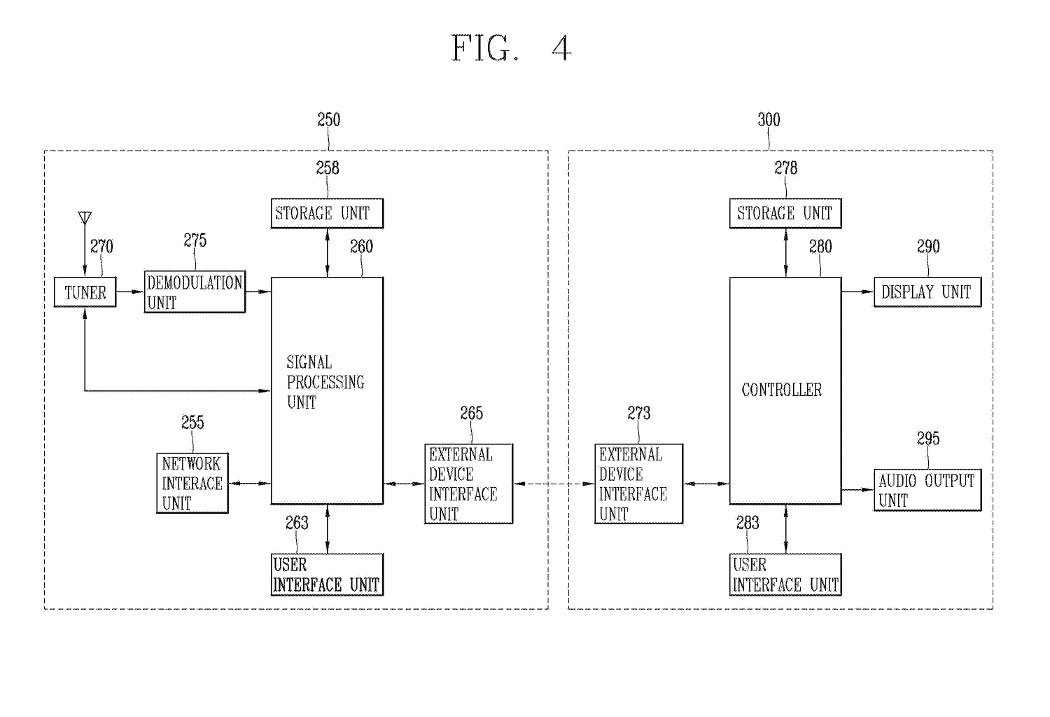

Meanwhile, the image display device 100 is an example of an image signal processing device for processing a signal of an image stored in the device or an input image. Another example of the image signal processing device may be a set-top box excluding the display unit 180 and the audio output unit 185, the foregoing DVD player, a blu-ray player, a game machine, a computer, or the like. Among them, the set-top box will now be described with reference to FIGS. 3 and 4.

FIGS. 3 and 4 are schematic block diagrams discriminately showing a set-top box (STB) and a display device of any one of image display devices according to exemplary embodiments of the present invention.

First, with reference to FIG. 3, a set-top box (STB) 250 and a display device 300 may transmit or receive data through a fixed line or wirelessly.

The STB 250 may include a network interface unit 255, a storage unit 258, a signal processing unit 260, a user input interface unit 263, and an external device interface unit 265.

The network interface unit 255 provides an interface for a connection with a wired/wireless network including the Internet. Also, the network interface unit 255 may transmit or receive data to or from a different user or a different electronic device through a connected network or a different network linked to the connected network.

The storage unit 258 may store programs for processing and controlling respective signals in the signal processing unit 260, or may serve to temporarily store an image, voice, or data signal input from the external device interface unit 265 or the network interface unit 255.

The signal processing unit 260 processes an input signal. For example, the signal processing unit 260 may demultiplex or decode an input image signal, and may demultiplex or decode an input voice signal. To this end, the signal processing unit 260 may include an image decoder or a voice decoder. The processed image signal or voice signal may be transmitted to the display device 300 through the external interface unit 265.

The user input interface unit 263 may transfer a signal input by the user to the signal processing unit 260 or transfers a signal from the signal processing unit 260 to the user. For example, the user input interface unit 263 may receive various control signals such as power ON/OFF, an operation input, a setup input, or the like, input through a local key (not shown) or the remote controller 200 and transfer the same to the signal processing unit 260.

The external device interface unit 265 provides an interface for transmitting or receiving data to and from an external device connected through a fixed line or wirelessly. In particular, the external device interface unit 265 provides an interface for a data transmission or reception with the display device 300. Besides, the external device interface unit 265 is able to provide an interface for a data transmission and reception with an external device such as a game machine, a camera, a camcorder, a computer (notebook computer), or the like.

Meanwhile, the STB 250 may further include a media input unit (not shown) for reproducing a media. The media input unit may be, for example, a blu-ray input unit (not shown), or the like. Namely, the STB 250 may include a blu-ray player. Media such as an input blu-ray disk, or the like, may be signal-processed, e.g., demultiplexed or decoded, by the signal processing unit 260 and then transmitted to the display device 300 through the external device interface unit 265.

The display device 300 may include a tuner 270, an external device interface unit 273, a demodulation unit 275, a storage unit 278, a controller 280, a user input interface unit 283, a display unit 290, and an audio output unit 295.

The tuner 270, the demodulation unit 275, the storage unit 278, the controller 280, the user input interface unit 283, the display unit 290, and the audio output unit 295 correspond to the tuner 110, the demodulation unit 120, the storage unit 140, the controller 170, the user input interface unit 150, the display unit 180, and the audio output unit 185 described above with reference to FIG. 2, so a description thereof will be omitted.

Meanwhile, the external device interface unit 273 provides an interface for a data transmission or reception with an external device connected through a fixed line or wirelessly. In particular, the external device interface unit 273 allows an image signal or a voice signal, which has been input through the STB 250, through the controller 170, the display unit 180, and the audio output unit 185.

Meanwhile, with reference to FIG. 4, the STB 250 and the display device 300 are the same as the STB 250 and the display device 300 illustrated in FIG. 3, except that the tuner 270 and the demodulation unit 275 are located within the STB 300, rather than within the display device 300. Hereinafter, the difference will be described.

The signal processing unit 260 may process a broadcast signal received through the tuner 270 and the demodulation unit 275. Also, the user input interface unit 263 may receive an input such as a channel selection, channel storing, or the like.

FIG. 5 is a detailed view showing a camera unit of an image display device according to an exemplary embodiment of the present invention.

According to an exemplary embodiment of the present invention, the camera unit may include a plurality of cameras for acquiring different types of information to obtain various types of information through the camera unit.

With reference to FIG. 5, the camera unit according to an exemplary embodiment of the present invention may include depth cameras 401 and 402, an RGB camera 403, a camera memory 404, a camera controller 405, and audio reception units 406 and 407. The depth cameras 401 and 402 may include a depth image sensor (a depth image CMOS) 401, and an infrared light source 402. The audio reception unit may include a microphone 406 and a sound source recognition unit 407.

As for the depth cameras, a pixel value recognized from an image captured by the depth cameras is the distance from the depth cameras.

The depth cameras include the image sensor 401 and the infrared light source 402. The depth cameras may use a scheme (TOF: Time Of Flight) in which an infrared ray is emitted from the infrared light source 402 and distance information between a subject and the depth cameras is obtained from a phase difference between the emitted infrared ray and an infrared ray reflected from the subject or a scheme (structured light) in which the infrared light source 402 emits infrared patterns (numerous infrared dots), the image sensor 401 having a filter captures an image of the infrared patterns reflected from a subject, and distance information between the subject and the depth cameras based on patterns distorted from the patterns.

Namely, the image display device is able to recognize location information of the subject through the depth cameras. In particular, when the subject is a person, the image display device may obtain location coordinates of each part of the person's body, and continuously detects a movement of the person's body parts according to location coordinates of the respective body parts to obtain information regarding specific movements of the body.

The RGB camera 403 obtains color information as a pixel value. The RGB camera may include three image sensors (CMOS) for obtaining information regarding each color of R (Red), G (Green), and B (Blue). Also, the RGB camera is able to obtain an image of relatively high resolution compared with the depth cameras.

The camera memory 404 stores set values of the depth cameras and the RGB camera. Namely, when a signal for capturing an image of a subject is input by using the camera unit from the user, the camera unit analyzes the input image through the controller 405 and loads the camera configuration values from the camera memory 404 according to the analysis results to configure (or set) an image capture environment of the depth cameras and the RGB camera.

Also, the camera memory 404 is able to store an image captured by the depth cameras and the RGB camera, and when a call signal of the stored image is input from the user, the camera memory 404 may load the stored image.

The microphone 406 receives a sound wave or an ultrasonic wave and transmits an electrical signal according to the vibration to the camera controller 405. Namely, when the user inputs a user's voice to the image display device through the microphone 406, the user's voice may be stored along with an image input through the depth cameras and the RGB camera and the image display device may be controlled to perform a certain operation through the input voice.

When the image display device uses certain contents and service, the sound source recognition unit 407 receives an audio signal of the contents or service in use and transmits an electrical signal according to the vibration to the camera controller 405. Namely, unlike the microphone 406, the sound source recognition unit 407 extracts the audio signal from the broadcast signal received by the image display device and recognizes it.

The camera controller 405 controls the operations of the respective modules. Namely, when an image capture start signal using the camera unit is received, the camera controller 405 provides control to capture an image of a subject through the depth cameras and the RGB camera, analyzes the captured image, loads configuration information from the camera memory 404, and controls the depth cameras and the RGB camera. Also, when an audio signal is input through the audio recognition unit, the camera controller 405 may store the input audio signal along with the image signal captured through the depth cameras and the RGB camera in the camera memory 404.

Through the foregoing configuration, the user is able to input a certain image and voice to the image display device, and control the image display device through the input image or voice.

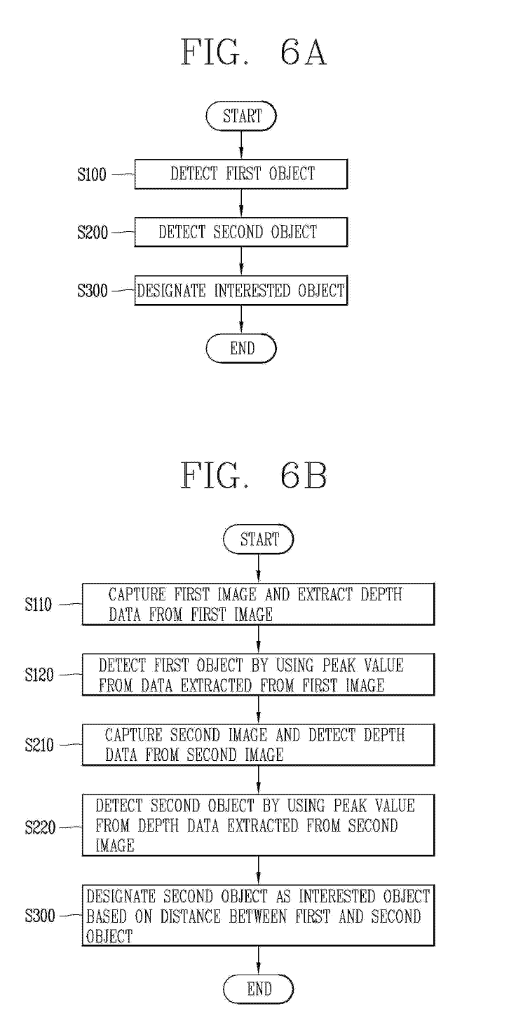

FIGS. 6A and 6B are flow charts illustrating the process of controlling an operation of the image display device according to an exemplary embodiment of the present invention.

With reference to FIG. 6A, the image display device captures a first image by using the camera unit, extracts depth data from the captured first image, and detects a first object by using a peak value of the depth data extracted from the first image (step S100).

The image display device captures a second image by using the camera unit, extracts depth data from the captured second image, and detects a second object by using the peak value of the depth data extracted from the second image (step S200).

The image display device designates the second object as an interested object based on the distance between the first and second objects (step S300).

With reference to FIG. 6B, the camera unit captures the first image through the depth camera according to a control signal of the image display device. Also, the camera unit may extract depth data from the captured first image (step S110). Accordingly, the image display device can obtain the distance between the respective pixels of the first image and the depth camera, as a pixel value.

The image display device may detect at least one object having a peak value from the depth data extracted from the first image (step S120). In this case, in order to detect at least one peak value from the depth data, the image display device may use various known arts.

For example, the image display device may calculate a mean of the pixel values and an average absolute deviation from the depth data. As the mean and the average absolute deviation, a median value and an average absolute deviation from the median value may be used.

The image display device may generate a binary image having the same size in which 1 is assigned to all the pixels having a depth value higher than a threshold value (m+Kσ) and 0 is assigned to the other pixels. The definition of K may vary depending on the amount of noise and the number of objects appearing on the image. Components connected in the binary image are recognized as one object, and a unique ID may be provided to the object.

In this manner, the camera unit may capture the second image through the depth cameras and extract depth data from the captured second image (step S210). Also, the image display device may detect at least one object having a peak value from the depth data extracted from the second image (step S220).

Also, the image display device compares the coordinates of the at least one object extracted in step S220 with the coordinates of at least one object extracted in step S120, and designates at least one object whose coordinates have been changed, as an interested object (step S300). Accordingly, two images are compared, and an object whose movement is detected is designated as an interested object, while an object whose movement is not detected is not designated as an interested object. Accordingly, the image display device discriminates a body part such as the user's hand and an object which does not move, and may designate the user's hand in motion as an interested object.

The at least one object designated as an interested object may be used as an input means of the image display device. For example, the user may apply a gesture to the image display device by using the interested object, and the image display device may interpret the applied gesture in response to the applied gesture, and execute a command according to the interpretation results.

Namely, when the user moves a body part designated as an interested object, the image display device captures an image of the motion through the camera unit and analyzes the captured image to shift a pointer displayed on the image display device.

Also, besides the movement of the pointer, various other functions such as channel up/down, volume up/down, or the like, displayed on the image display device may be manipulated.

The process for controlling the operation of the image display device according to an exemplary embodiment of the present invention will now be described. In the following description, the image display device may extract depth data from an image obtained by the camera unit. Also, the image display device may generate a three-dimensional (3D) depth image based on the extracted depth data, and here, 2D image viewed from above is illustrated for the sake of brevity. Namely, it means that as a y value of each depth image increases, the corresponding pixel is positioned to be close to the camera unit.

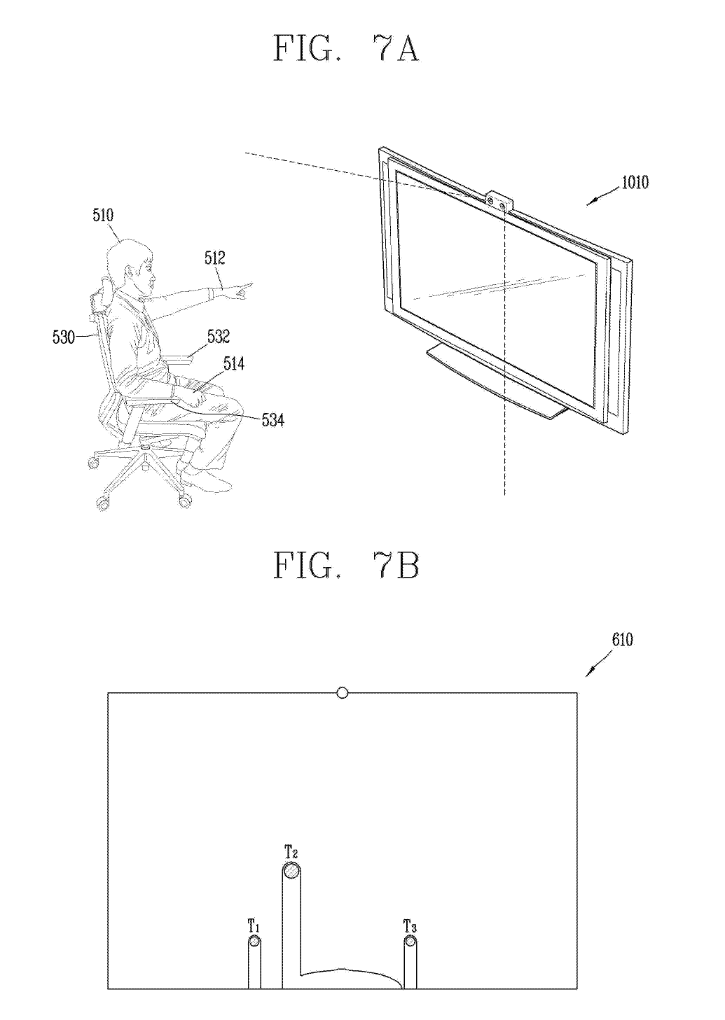

FIGS. 7A and 7B are views for explaining the process of designating an interested object according to an exemplary embodiment of the present invention.

With reference to FIG. 7A, the user 510 may be located along with an object 530. The camera unit may capture an image, and accordingly, the image display device can obtain an image of the user 510 and that of the object 530. The image display device extracts depth data from the obtained image and generate a depth image based on the extracted depth data.

With reference to FIG. 7B, with the depth image 610 generated, the image display device may detect at least one object having a peak value from the depth image 610. As a result, three objects T1, T2, and T3 may be detected from the depth image 610. A unique ID may be provided to each of the objects T1, T2, and T3. The object T1 corresponds to a partial area 532 of the object 530, the object T2 corresponds to the user's left arm 512, and the object T3 corresponds to the user's right arm 514 and another partial area 534.

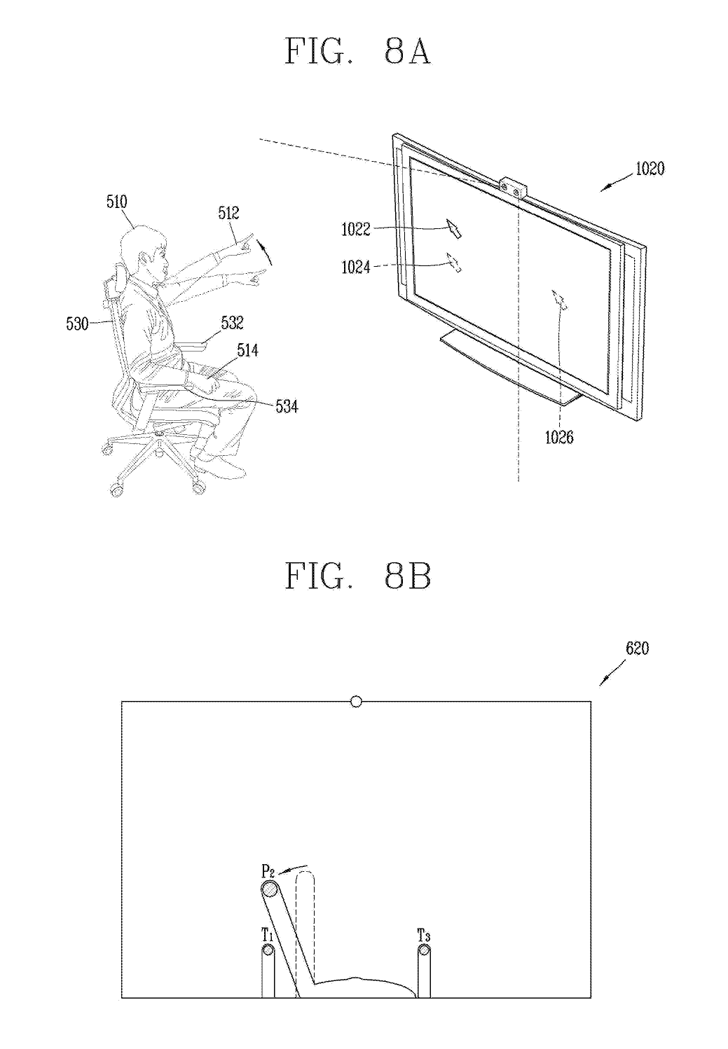

FIGS. 8A and 8B are views for explaining the process of designating an interested object according to an exemplary embodiment of the present invention.

With reference to FIG. 8A, in a state in which the user 510 maintains the position of his right arm 514, the user 510 may move his left arm 512. The camera unit may capture a corresponding image, and accordingly, the image display device can obtain an image of the user 510 and the object 530. The image display device may extract depth data from the obtained image and generate a depth image based on the extracted depth data.

With reference to FIG. 8b, with the depth image 620 generated, the image display device may detect at least one object having a peak value from the depth image 620. As a result, three objects T1, P2 and T3 may be detected from the depth image 620. A unique ID may be provided to each of the objects T1, P2, and T3.

In this state, the image display device compares the positions of the at least one objects detected from the captured image with the positions of the at least one objects T1, T2, and T3 detected from the captured image in FIG. 7B, and detects an object whose position has been changed. In this case, the positions of the objects T1 and T3 are the same, but the position of the object P2 is not identical to the position of the object T2, so the image display device may determine that the object P2 has moved.

Accordingly, the image display device may designate the object P2 as an interested object. The image display device may continuously track the position of the object P2 designated as an interested object. The image display device may interpret the user's gesture based on the change in the position of the object P2 and control the operation of the image display device in response to the gesture.

Meanwhile, the objects T1 and T3, which have not been designated as an interested object, may have a possibility of being designated as an interested object, so they may maintain their ID. For example, an object detected to have moved in the next image obtained by the camera unit may be designated as a new interested object.

Also, as shown in FIG. 8A, an indicator 1022 projecting the position of the interested object on a screen 1020 may be displayed on the screen 1020 of the image display device. Also, although not designated as an interested object, indicators 1024 and 1026 projecting the positions of the objects detected to have a peak value from a previous depth image may be displayed to be discriminated from the indicator 1022 on the screen 1020.

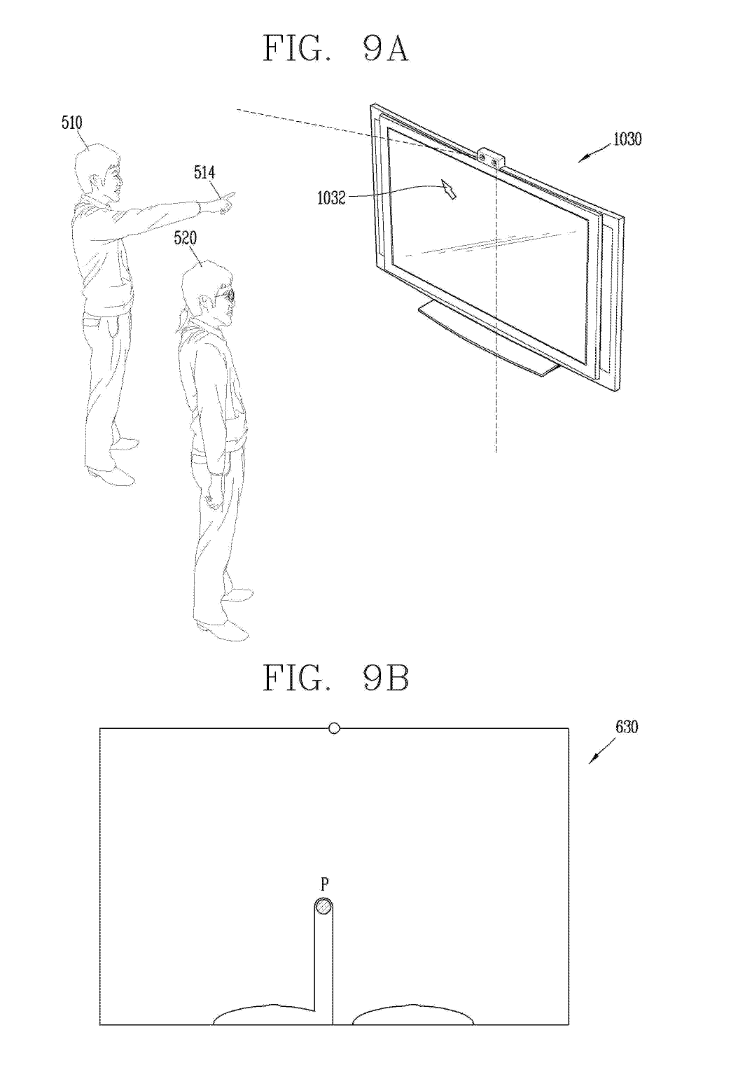

FIGS. 9A and 9B are views for explaining the process of tracking an interested object according to an exemplary embodiment of the present invention.

With reference to FIG. 9A, in a state in which the user 510 is located along with a user 520, the user 510 may make a motion of stretching his right arm 514 to the front. The camera unit may capture a corresponding image, and accordingly, the image display device can obtain an image of the user 510 and that of the user 520. The image display device may extract a depth data from the obtained images and generate a depth image based on the extracted depth data.

With reference to FIG. 9B, with the depth image 630 generated, the image display device may detect at least one object having a peak value from the depth image 630. As a result, an object (P) is detected from the depth image 630, and since the position of the object (P) has been changed from that of the previous image obtained by the camera unit, the object (P) may be designated as an interested object.

Also, as shown in FIG. 9A, an indicator 1032 projecting the position of the interested object on a screen 1030 may be displayed on the screen 1030 of the image display device.

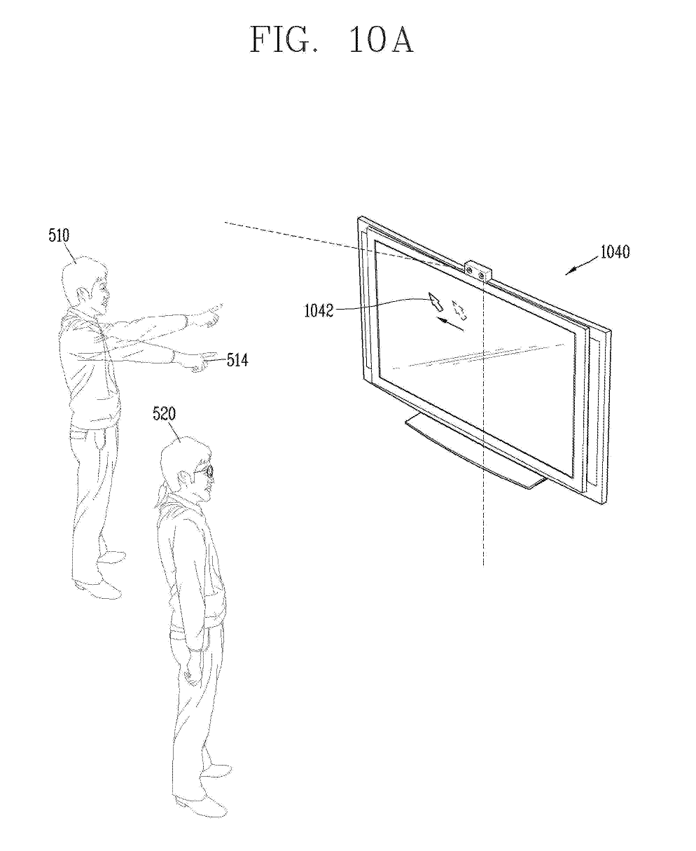

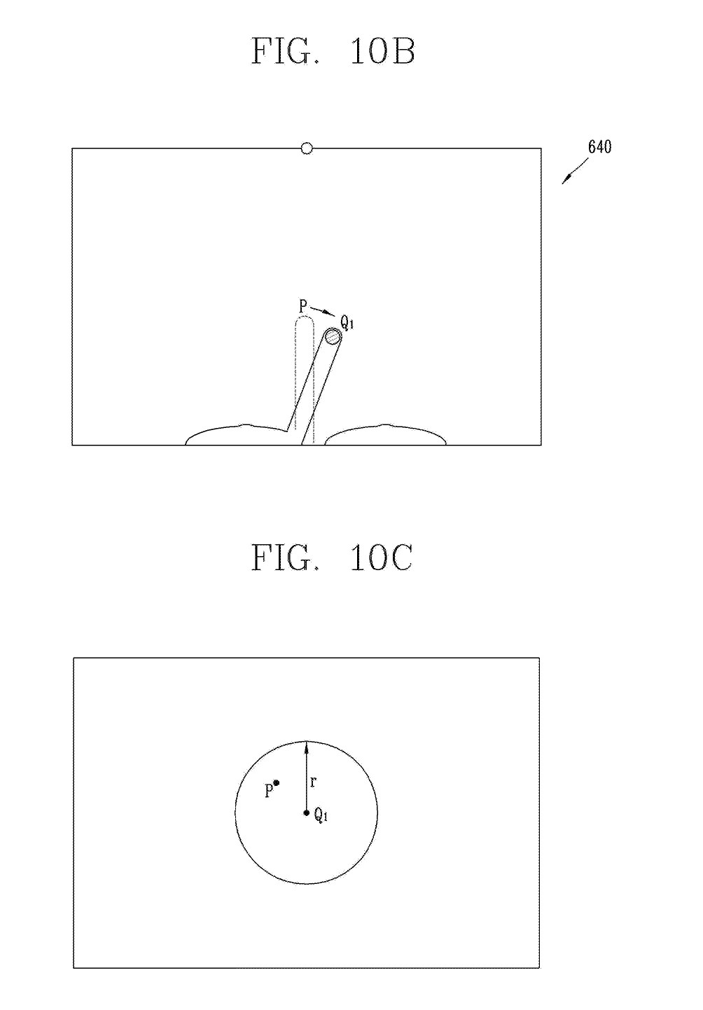

FIGS. 10A to 10C are views for explaining the process of tracking an interested object according to an exemplary embodiment of the present invention.

With reference to FIG. 10A, the user 510 and the user 520 are located together, and in a state in which the user 510 stretches out his right arm 514 as shown in FIG. 9A, the user 510 may take action of moving his right arm 514 to the right. The camera unit may capture a corresponding image, and accordingly, the image display device may obtain images of the user 510 and the user 520. The image display device may extract depth data from the obtained image and generate a depth image based on the extracted depth data.

With reference to FIG. 10B, a depth image 640 is generated, and the image display device may detect at least one object having a peak value from the depth image 640. As a result, an object Q1 may be detected from the depth image 640. The image display device may compare the position of the object (P) designated as an interested object in the previous image and the position of the object Q1 detected from the current image, and calculate the distance therebetween.

With reference to FIG. 10C, when the distance between the object Q1 and the object (P) is shorter than r, the object Q1 is determined to be the same object as the object (P), and the same ID as that of the object (P) may be assigned to the object Q1. The position of the object Q1 may be tracked in the same manner in a next image.

Here, r refers to the distance by which the body part of the user can move per unit time, and may refer to a maximum distance by which the body part of the user may move between the image obtaining time of FIG. 9B and that of FIG. 10B. For example, r may be the distance by which the user's hand is movable per unit time.

Also, as shown in FIG. 10A, an indicator 1042 projecting a new position of the interested object on a screen 1040 may be displayed on the screen 1040 of the image display device.

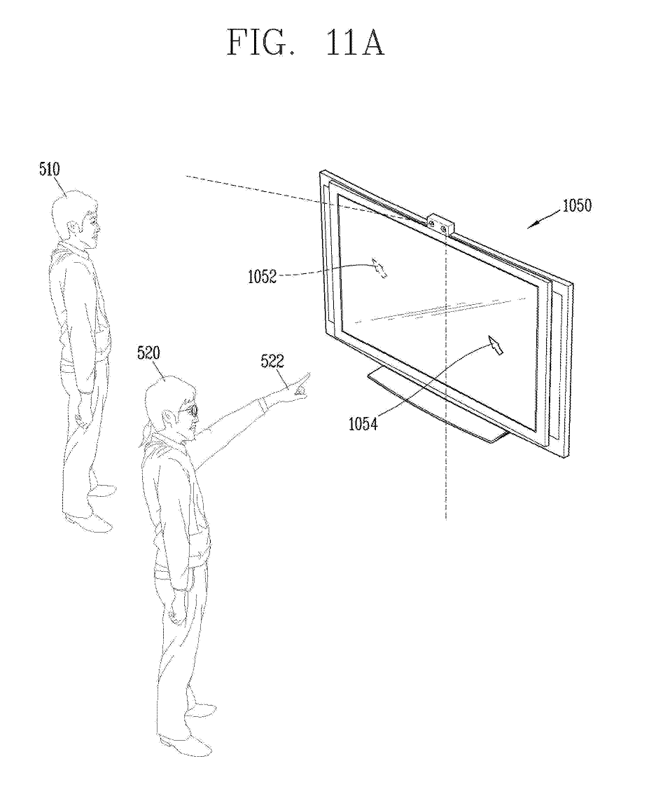

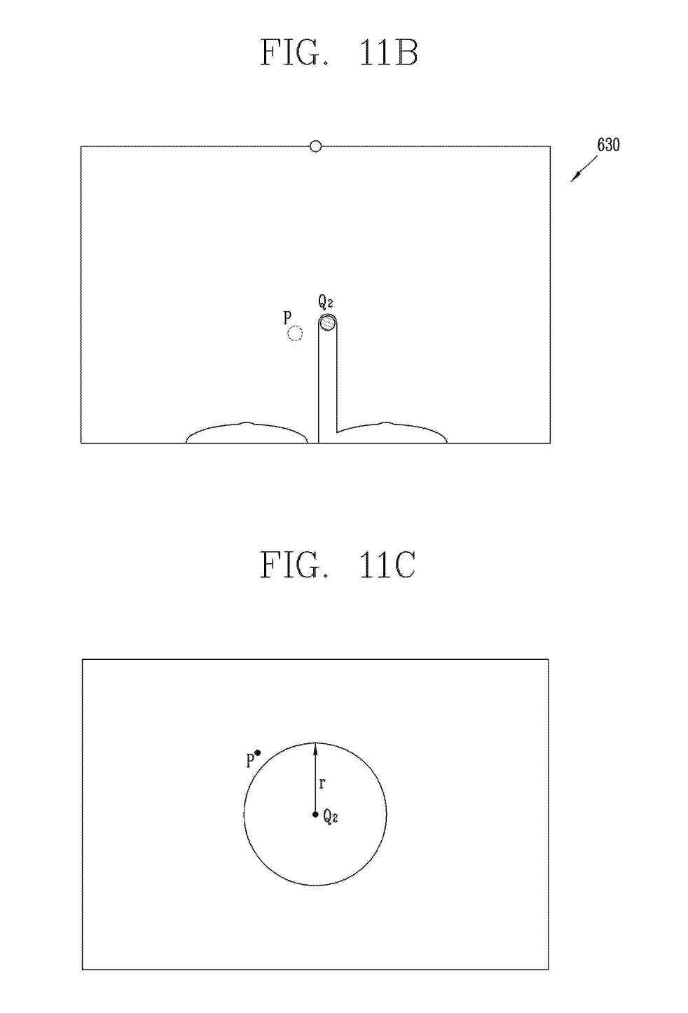

FIGS. 11A to 11C are views for explaining the process of tracking an interested object according to an exemplary embodiment of the present invention.

With reference to FIG. 11A, the user 510 and the user 520 are located together, and in a state in which the user 510 stretches out his right arm 514 as shown in FIG. 9A, the user 510 may take action of putting down his right arm 514 and the user 520 may take action of stretching out his left arm 522. The camera unit may capture a corresponding image, and accordingly, the image display device may obtain images of the user 410 and the user 520. The image display device may extract depth data from the obtained image and generate a depth image based on the extracted depth data.

With reference to FIG. 11B, a depth image 650 is generated, and the image display device may detect at least one object having a peak value from the depth image 650. As a result, an object Q2 may be detected from the depth image 650. The image display device may compare the position of the object (P) designated as an interested object in the previous image and the position of the object Q2 detected from the current image, and calculate the distance therebetween.

With reference to FIG. 11C, when the distance between the object Q1 and the object (P) exceeds r, the object Q2 is determined to be a different object from the object (P), and a new unique ID may be assigned to the object Q2. The position of the object Q2 may be tracked in the same manner in a next image.

Also, as shown in FIG. 11A, an indicator 1054 projecting the position of the newly interested object on a screen 1050 may be displayed on the screen 1050 of the image display device.

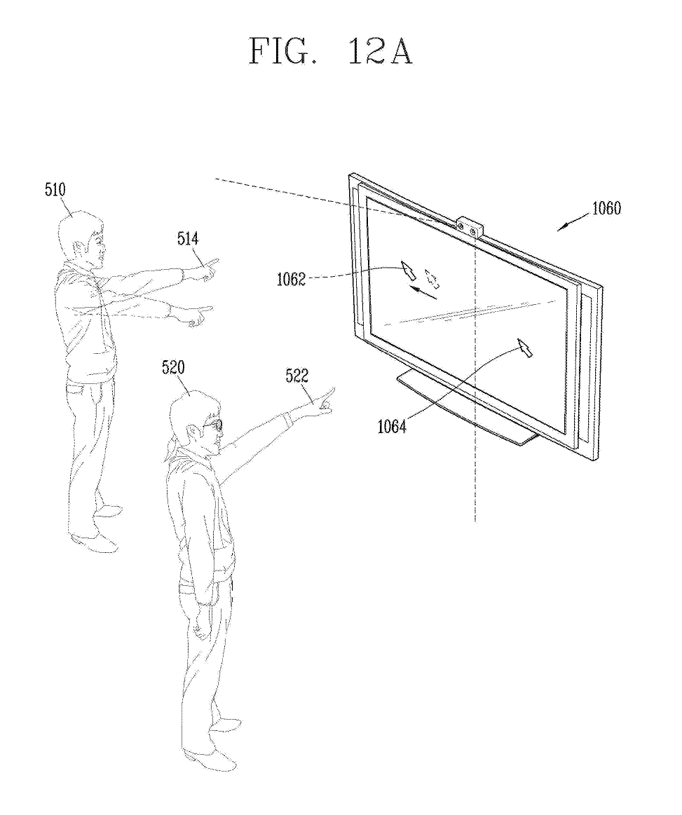

FIGS. 12A to 12C are views for explaining the process of tracking an interested object according to an exemplary embodiment of the present invention.

With reference to FIG. 12A, the user 510 and the user 520 are located together, and in a state in which the user 510 stretches out his right arm 514 as shown in FIG. 9A, the user 510 may take action of moving his right arm 514 to the left and the user 520 may take action of stretching out his left arm 522. The camera unit may capture a corresponding image, and accordingly, the image display device may obtain images of the user 510 and the user 520. The image display device may extract depth data from the obtained image and generate a depth image based on the extracted depth data.

With reference to FIG. 12B, a depth image 660 is generated, and the image display device may detect at least one object having a peak value from the depth image 660. As a result, objects Q3 and Q4 may be detected from the depth image 660. The image display device may compare the position of the object (P) designated as an interested object in the previous image and the positions of the objects Q3 and Q4 detected from the current image, and calculate the distance therebetween.

With reference to FIG. 12C, when the distance between the objects Q3 and Q4 and the object (P) is shorter than r, the image display device determines an object, among the objects Q3 and Q4, closer to the object (P), and assigns the same ID as that of the object (P) to the object Q3 closer to the object (P).

Also, the image display unit may assign a new unique ID to the object Q4 farther from the object (P). The positions of the objects Q3 and Q4 may be tracked in the same manner in a next image.

Also, as shown in FIG. 12A, an indicator 1062 projecting the changed position of the interested object and an indicator 1064 projecting the position of the new interested object on the screen 1060 may be displayed on the screen 1060 of the image display device.

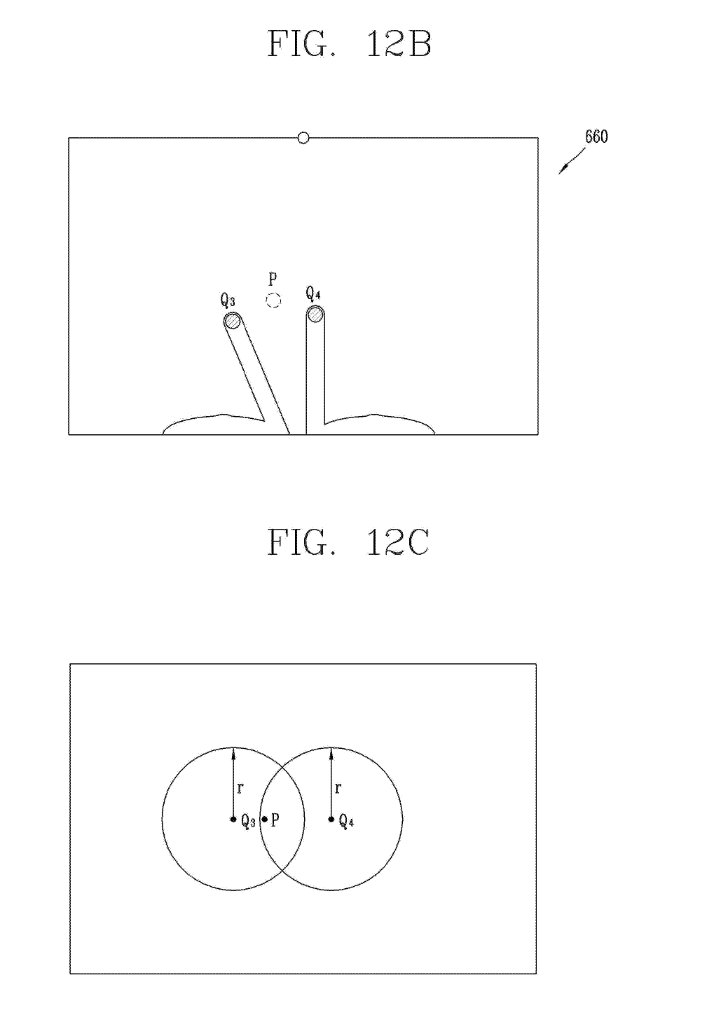

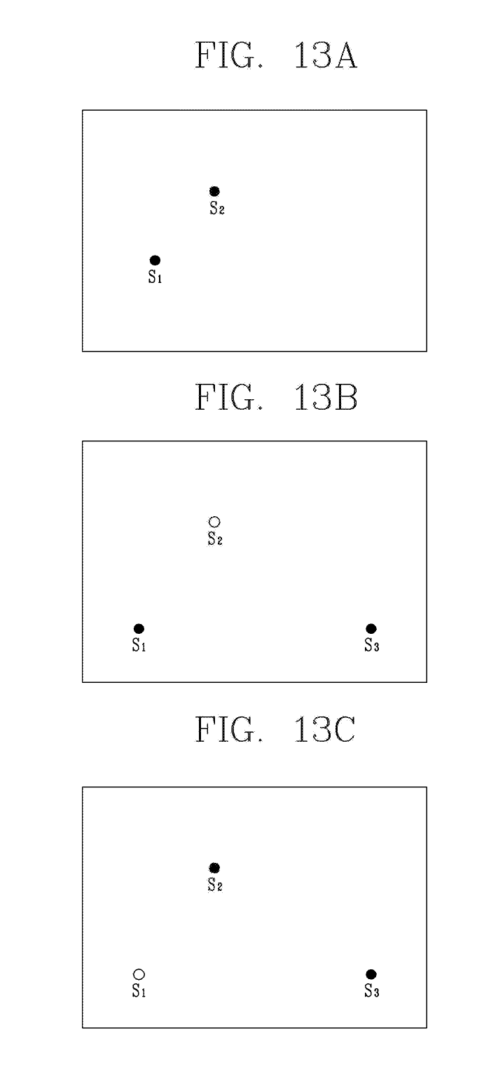

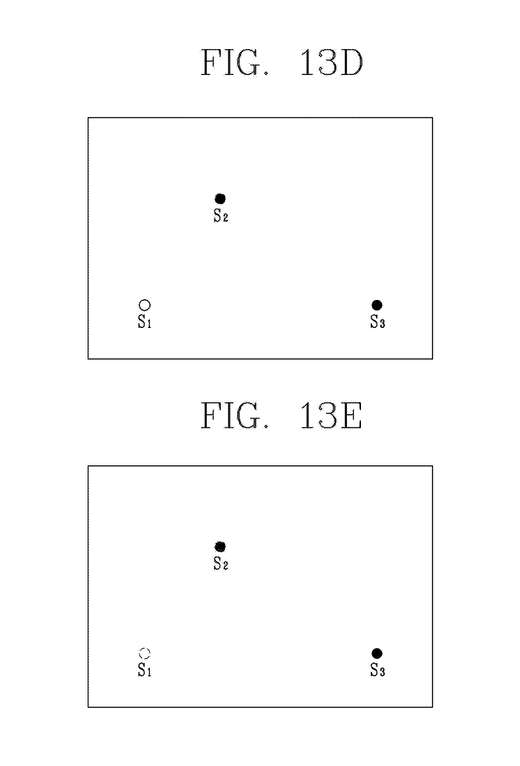

FIGS. 13A to 13E are views for explaining the process of maintaining or releasing a designated interested object according to an exemplary embodiment of the present invention. In each drawing, objects in black color refer to those detected from a corresponding frame, and otherwise objects (i.e., objects in white color) refer to those not detected from the corresponding frame.

In a first frame of FIG. 13A, an object S1 and an object S2 may be designated as interested objects according to the difference in position between a previous frame and a current frame.

In a second frame of FIG. 13B, the object S1 may be continuously detected, and an object S3 may be newly detected. However, the second object S2 may not be detected. In this case, an ID of the object S2 is not immediately deprived in case in which the object S2 is detected again in a next frame (namely, the designated of the interested object is not released).

In a third frame of FIG. 13C, the object S3 is continuously detected, and the second object S2 may be detected again. However, the object S1 may not be detected. In this case, since the object S2 is detected again from the current frame, the assigned ID may be maintained. Also, an ID of the object S1 is not immediately deprived in case in which the object S1 is detected again in a next frame (namely, the designated of the interested object is not released).

In a fourth frame of FIG. 13D, the objects S2 and S3 are continuously detected, while the object S1 may not be detected. In this case, the object S1 is not highly likely to be detected in a next frame, so its ID may be deprived (its designation of interested object may be released).

In a fifth frame of FIG. 13E, the objects S2 and S3 are maintained with their ID, while the object S1 may be deprived of its ID so as to become extinct (namely, its designation of interested object may be released).

In this manner, in the image display device, when an object designated as an interested object, its ID can be maintained if it is not continuously detected in certain number of frames.

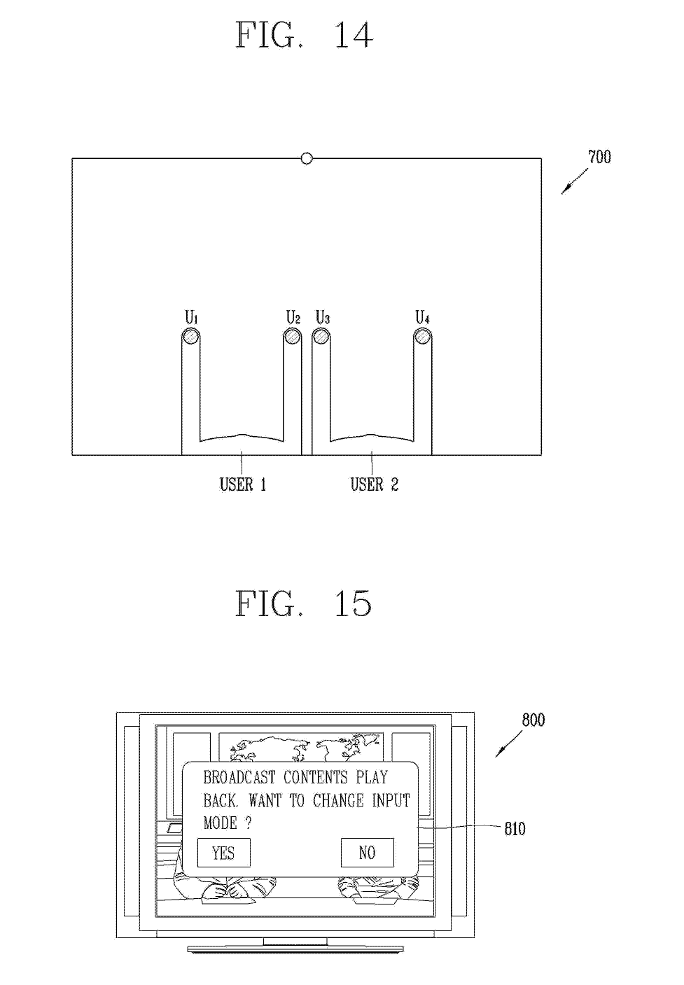

FIG. 14 is a view for explaining the process of detecting an object according to an exemplary embodiment of the present invention.

When a gestures is recognized in case in which at least two objects are designated as interested objects in a depth image, the two interested objects must be discriminated. In this case, the image display device may extract patterns of a depth value from the depth image and designate the interested objects based on the extracted patterns. The patterns of the depth value may include information regarding the user's shape or information regarding the user's posture.

With reference to FIG. 14, a depth image 700 is formed, and the image display device may detect at least one object having a peak value from the depth image 700. As a result, objects U1, U2, U3, and U4 may be detected from the depth image 700. The image display device may recognize the entire object (USER1) including objects U1 and U2 and the entire object (USER2) including objects U3 and U4 in consideration of connectivity in the depth image, and discriminately designate the objects U1 and U2 and the objects U3 and U4 as interested objects. Thus, the objects U1 and U2 and the objects U3 and U4 may be assigned different IDs.

FIG. 15 is a view for explaining the process of detecting an object according to an exemplary embodiment of the present invention.

In tracking an interested object, a camera unit may further use an RGB camera. For example, the camera unit may obtain a depth image and an RGB image and recognize a user gesture by using a skeleton model. The image display device may obtain a depth image and an RGB image and determine whether or not a target or an object is a human being in the obtained depth image or the RGB image. When the target or the object is a human being, the camera unit may render an avatar model by comparing the human being with a skeleton model and detect his gesture to perform an operation.

In this case, the image display device may recognize gestures of various body parts based on the respective skeleton models of the human body, and in this case, the amount of calculation is increased and the hardware may be burdened. Thus, the image display device may determine the type of reproduced contents and use a different input method according to the type of the contents.

For example, when the type of reproduced contents is interactive contents, the image display device may recognize a gesture based on a skeleton model using a depth image and an RGB image and perform an operation. Meanwhile, when the type of the reproduced contents is not interactive contents, the image display device may recognize a gesture and perform an operation based on a peak value using a depth image.

Or, when the type of the reproduced contents is broadcast contents, the image display device may recognize a gesture and perform an operation based on a peak value using a depth image. Meanwhile, when the type of the reproduced contents is not broadcast contents, the image display device may recognize a gesture and perform an operation based on a skeleton model using a depth image and an RGB image.

With reference to FIG. 15, while contents, rather than broadcast contents, are being reproduced, the image display device may reproduce broadcast contents according to a corresponding result. In this case, the image display device may display a guide message 810 for changing an input mode on a screen 800.

When an input mode is changed according to the guide message 810, the image display device may recognize the gesture based on the peak value using the depth image and perform a corresponding operation. According to an exemplary embodiment, the image display device may display a guide message 810 and automatically change the input mode, or may immediately change the input mode without displaying the guide message 810.

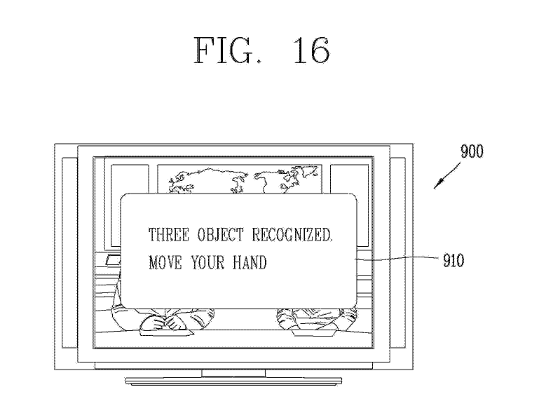

FIG. 16 is a view for explaining the process of detecting an object according to an exemplary embodiment of the present invention.

The image display device sequentially may obtain a plurality of images by using the camera unit and detect at least one object by using a peak value of a depth image from each of the obtained images. In this case, when no object is designated as an interested object because there is no movement of an object detected from each image, the image display device may generate guide information for designating an interested object and display the same on the screen.

With reference to FIG. 16, although three objects are detected in an input standby mode, there is no object designated as an interested object continuously. In this case, the image display device may display guide information 910 for moving a body part related to the detected objects on the screen 900. According to the user's movement, a change in the position of an object may be detected in a follow-up image, so the object related to the movement may be designated as an interested object.

According to an exemplary embodiment of the present invention, the image display device can quickly detect an object for recognizing a user's gesture by using depth data. Also, according to an exemplary embodiment of the present invention, the image display device can accurately determine a user's intention for controlling the device. Also, according to an exemplary embodiment of the present invention, since the input mode is differentiated according to the contents reproduced in the image display device, an input means can be optimized.

In the embodiments of the present invention, the above-described method can be implemented as codes that can be read by a processor in a processor-readable recording medium. The processor-readable medium includes various types of recording devices in which data read by the processor is stored. The processor-readable medium may include, for example, a ROM, a RAM, a CD-ROM, a magnetic tape, a floppy disk, an optical data storage device, and the like. The computer-readable medium also includes implementations in the form of carrier waves or signals such as a transmission via the Internet. Also, the process-readable recording medium may be distributed to a computer system connected to a network and codes which can be read by the processor may be stored and executed in a distributed manner.

As the exemplary embodiments may be implemented in several forms without departing from the characteristics thereof, it should also be understood that the above-described embodiments are not limited by any of the details of the foregoing description, unless otherwise specified, but rather should be construed broadly within its scope as defined in the appended claims. Therefore, various changes and modifications that fall within the scope of the claims, or equivalents of such scope are therefore intended to be embraced by the appended claims.

What is claimed is:

1. A method for controlling an operation of an image display device, the method comprising:
capturing a first image by using a camera and extracting depth data from the captured first image;
detecting a first object by using a peak value from the depth data extracted from the first image;
capturing a second image by using the camera and extracting depth data from the captured second image;
detecting a second object by using a peak value from the depth data extracted from the second image; and
designating the second object as an interested object based on the distance between the first and second objects.

2. The method of claim 1, further comprising:
capturing a third image by using the camera and extracting depth data from the captured third image;
detecting a third object by using a peak value from the depth data extracted from the third image; and
maintaining or releasing the designated interested object based on the distance between the interested object and the third object.

3. The method of claim 2, further comprising:
storing the distance by which a body part of a user is movable by unit time,
wherein in maintaining or releasing the designated interested object, the designated interested object is maintained or released further based on the distance by which the body part of the user is movable by unit time.

4. The method of claim 1, further comprising:
capturing a third image by using the camera and extracting depth data from the captured third image;
detecting third and fourth objects by using a peak value from the depth data extracted from the third image; and
maintaining or releasing the designated interested object based on the distance between the interested object and the third object and the distance between the interested object and the fourth object.

5. The method of claim 1, further comprising:
displaying a first indicator reflecting the location of the interested object.

6. The method of claim 5, further comprising:
displaying a second indicator reflecting the locations of the first and second objects such that the second indicator is differentiated from the first indicator.

7. The method of claim 1, wherein the extracting of the depth data from the captured second image comprises extracting user's shape information or user's posture information from the captured second image, and in determining the second object as an interested object, the second object is designated as an interested object based on the user's shape information or posture information.

8. The method of claim 1, further comprising:
displaying guide information related to the location of the second object on a screen.

9. The method of claim 1, further comprising:
detecting a user's gesture through the interested object; and
executing a command corresponding to the gesture in response to the gesture.

10. The method of claim 1, further comprising:
determining the type of reproduced contents,
wherein, in designating the second object as an interested object, the second object is designated as an interested object further based on the type of the contents.

11. The method of claim 10, wherein the type of the reproduced contents is classified according to whether or not the reproduced contents are interactive contents.

12. The method of claim 10, wherein the type of the reproduced contents is classified according to whether or not the reproduced contents is broadcast contents.

13. An image display device comprising:
a camera configured to capture a first image and a second image following the first image; and
a controller configured to extract depth data from each of the captured first and second images, detect first and second objects each having a peak value from each of the extracted depth data, and designate the second object as an interested object based on the distance between the first and second objects.
